(19) United States
(12) Patent Application Publication
(10) Pub. No.: US 2026/0302700 A1
(43) Pub. Date: Oct. 1, 2026

(54) AN ULTRA-COMPACT, VERY HIGH-FREQUENCY BOARD-TO-BOARD COAXIAL CONNECTION SYSTEM

(71) Applicant: RADIALL SA, Aubervilliers (FR)

(72) Inventors: Alan HU, Jiading District (CN); Claude BROCHETON, Coublevie (FR)

(21) Appl. No.: 19/571,699

(22) Filed: Mar. 19, 2026

Related U.S. Application Data
(63) Continuation of application No. PCT/CN2025/086165, filed on Mar. 31, 2025.

(51) Int. Cl. H01R 24/50; H01R 103/00

(52) U.S. Cl. CPC H01R 24/50; H01R 2103/00

(57) ABSTRACT

The present application relates to a coaxial connection system, suitable to connect two printed circuits boards (PCB1, PCB2) or one board to a filter or one board to a module, for transmitting radio frequency, RF signals, which includes a spring-loaded adapter which connection interfaces are in some way hybrid because the electrical contacts are made radially for the outer contacts and axially at the end for the central contacts.

### DESCRIPTION

Title: An ultra-compact, very high-frequency board-to-board coaxial connection system.

### TECHNICAL FIELD

The present invention relates to the field of electrical connection and to a Radio Frequency (RF) coaxial connection system.

More particularly it relates to a coaxial connection system for transmitting RF signals from a radio board to a board supporting the radiating elements of an electronically scanned antenna for telecommunications and radar systems.

The present invention mainly aims to bring new and innovative solutions to cumulative problems of dimensional compactness, board positioning tolerances in the three X,Y and Z axes, and RF performance stability satisfying the frequency increase in the X band for cellular telecommunications systems or Ka band for AESA radar applications (acronym of “Active Electronically Scanned Array”), which are not addressed by existing solutions such those already commercialized as SMP-MAX, SMPM spring bullet, IMP-HD, IMP-SR series ….etc.

Such a system can in particular be used to connect two parallel or orthogonal printed circuits, usually called a board-to-board (B2B) or printed circuit board (PCB) connection, to another component such as a module or a filter, generally called board-to-filter or board-to-module.

The applications particularly targeted by the invention are the connection of telecommunication equipment.

The invention also generally relates to interconnection systems in the telecommunications field, in the medical field, in the industrial field, in the aeronautical field, in the transport field and in the space field.

The system according to the invention can in particular be used to connect two parallel or orthogonal printed circuits, usually called a board-to-board or printed circuit board connection system, to another component such as a module, a filter or a power amplifier or an antenna, or module-to-module.

“RF connection system” means a system capable of transmitting signals from the direct current (DC) range to the radio frequency (RF) range, including the microwave (HF) range, the signals being high speed data link (HSDL) digital signals or radio frequency (RF) signals.

### PRIOR ART

With the continuous development of wireless communication technology, board-to-board connectors are increasingly being used in the interconnection of wireless system modules, such as communication base stations, RRHs, repeaters, GPS devices and other similar applications. The top three trends in wireless devices are smaller dimensions, lower cost and easier installation, and also the upscaling of the frequency of the RF signals used. For a board-to-board connection, the market also requires the boards to be smaller, cheaper and more modularized.

Examples of connection assemblies dedicated to the telecommunications sector for cellular radiotelephony interconnections already exist on the market and in the prior art. This is because the trend in this market is to minimize the losses of the RF (radio frequency) part in order to reduce the amplifier components of the base stations. To that end, firstly, the present radio part of the stations is increasingly being relocated as close as possible to the transmit-receive antennas, in the RRU/RRH transmitter modules, and, secondly, the RF cables internal to the radio units are replaced by direct interconnections.

So-called board-to-board connections have thus developed over successive generations of the last decade.

There are already commercial products for producing these connections.

Current solutions for transmitting RF signals between two boards can be classified into three types.

The first is a system consisting of a sliding base, a snap-in base, and an adapter allowing for axial and radial tolerances. There are many interconnects of this type on the market, mainly intended for the telecom market, for radio heads of 4G/5G cellular networks, such as the SMP-MAX, the Power-Max Ultra, the RSMP, the HSMP, the P-SMP series, etc.

The limitation of this type of interconnection lies in the high impedance variation in the overlap zone between the sliding base and the adapter, which limits RF performance to the DC-6GHz band. Thus, this type of interconnection cannot under any circumstances go beyond 10 GHz without a drastic reduction in axial tolerance.

Reference may be made to patent EP2304852B1 relating to a connector of the SMP-Max series comprising a dumbbell-shaped electrical insulator where a high impedance zone is compensated by a low impedance zone limiting the bandwidth.

The second type is a floating system including a spring-loaded adapter, this latter allowing to solve the impedance variation in the overlap zone between a sliding base and an adapter. Indeed, the spring with constant impedance makes it possible to keep the reference planes of the bases and the adapter in contact whatever the distance between two boards.

This type of interconnection system has been adapted to the SMP and SMPM series under the name "spring bullet", as it is disclosed in US11,539,167 B2.

The limitation of such a system is its low compactness due to the combination of receptacles and the constant-impedance spring, which increases the space requirement by at least three, due to axial tolerances. Additionally, due to the pin and socket central contacts, the rotation of the so-called “spring bullet” is greatly reduced to a few degrees, which severely limits the acceptable radial misalignment, which can only be increased by increasing the length of the spring bullet.

The third is a system making the interconnection by pressure at the end of contacts.

In order to gain axial compactness, such systems with axial direct pressure on printed circuit boards have been developed. The most known are the IMP-HD and IMP-LP connectors. This type of interconnection system allows for significant gains in axial compactness due to the elimination of sliding and snap-in bases.

However, the system does not allow for any parallelism errors, and the radial tolerance between boards is extremely limited because it results in the central and external contacts being offset from their target. This also has the disadvantage of significantly degrading RF performances depending on the offset.

Nowadays, footprint requirements must be increasingly reduced given the increasing density.

For telecom applications, the required length between the two boards to be interconnected is around 11 mm, for a diameter of around 4 mm. In radar applications, the required length decreases to approximately 7.5 mm, for a diameter of approximately 2 mm, including the spring in the case of a spring-loaded system.

Furthermore, with increasing frequencies, particularly in the X band for the telecom applications, i.e. between 8 to 12 GHz, and in Ka and V bands, for products intended for electronic scanning antennas, i.e. between 27 to 31 GHz, and 40 to 75 GHz respectively, any impedance mismatch must be dimensionally reduced, or even eliminated, to avoid impacting signal transmission. However, the need for axial and radial misalignments remains high.

Therefore; there is a need to further improve board-to-board or board-to-module or board-to-filter connections, more particularly to solve the problems of significant axial misalignment and radial misalignment with high RF performances at very high frequency, notably in X, K and V bands, corresponding to those of interfaces having electrical reference planes in contact with the board, while being very compact in the longitudinal axis.

The invention aims to address all or part of this need.

### SUMMARY OF THE INVENTION

To this end, the invention relates, according to one of its aspects, to a coaxial connection system, suitable to connect two printed circuits boards (PCB1, PCB2) or one board to a filter or one board to a module, for transmitting radio frequency, RF signals, said system having a longitudinal axis X and comprising:

two annular receptacles or rings, each intended to be in mechanical and electrical contact with one ground trace of the board or the filter or the module;

a spring-loaded adapter including:

two central contacts sliding into each other,

two outer contacts sliding each other, each of the two outer contacts being mechanically guided by one of the two annular receptacles or rings and mechanically retained with and coaxially arranged around one of the two central contacts, and

an helical spring arranged around the two outer contacts,

wherein each of the two central contacts is configured to ensure an electrical continuity by an axial mechanical pressure of its free end whereas each of the two outer contacts is configured to ensure an electrical continuity by a radial deformation of its free end.

“By electrical continuity”, it is meant that the electrical path of the electrical current is continuous through the connection system.

Advantageously, the outer contacts are configured to not be in mechanical contact with two printed circuits boards (PCB1, PCB2) or the board and the filter or the board and the module.

Advantageously also, the central contacts are configured to be in direct mechanical contact by their free end with two printed circuits boards (PCB1, PCB2) or the board and the filter or the board and the module.

Preferably, the free end of each of the central contacts has a spherical portion shape. In other words, their free ends are shaped as a spherical portion.

According to advantageous variant embodiment, the free end of each of the outer contact central contact is slotted defining contact petals each shaped at its front end with a bump. The petals are radially deformed and thus the bumps thus define the electrical contact surfaces.

According to another advantageous embodiment, the system comprises four impedance lines, each of the two end lines including an electrical insulating body interposed and retained between one of the two central contacts and the two outer contacts, each of the two inside lines being devoid of devoid of a solid electrical insulator.

Preferably, the diameter of one of the central contact is decreasing from at least one of the end lines to the intermediate lines.

Preferably also, the external diameter of the outer contacts in end lines is larger than in intermediate lines.

According to another advantageous embodiment, one of the two receptacles is of a sliding type whereas the other receptacle is of the snap-on type.

At least one of the outer contacts may comprise at least one lug intended to be used for permanent electrical and mechanical connection to a printed circuit board (PCB1, PCB2).

Preferably, at least one receptacle receptacle accommodates an O-ring or a toroidal spring retaining one of the two outer contacts. An O-ring or a toroidal spring allows axial straightening of the adapter.

According to an advantageous embodiment, each of the receptacles accommodates a cavity filter.

According to an advantageous embodiment, one of the two receptacles is assembled with a terminal to make a perpendicular board-to-board connection.

In another embodiment, the annular rings are mechanically retained by the outer contacts and thus assembled with the adapter. Thus, in this embodiment, the system is constituted only by the adapter which retains the annular rings which ensures the electrical contact with the ground trace of PCBs or of a module.

The invention concerns also a connection module, intended to be used to link two printed circuit boards (PCB1, PCB2) comprising:

at least one coaxial connection system constituted by the adapter such as described above;

a holder comprising a frame with at least one opening in which the adapter is accommodated according to a floating mounting.

According to an advantageous embodiment, the frame comprises a plurality of openings arranged parallel to each other, in each of which one of the adapters is accommodated according to a floating mounting.

Thus, the invention essentially consists of a RF coaxial connection system with a spring-loaded adapter which connection interfaces are in some way hybrid because the electrical contacts are made radially for the outer contacts and axially at the end for the central contacts.

The helical spring of the adapter exerts a compression force to produce the electrical connection between, firstly, at one of the longitudinal ends of the connection system, one of the central contact tip and one of the outer contact radial end and, respectively, the signal line and the ground line of a first printed circuit board (PCB1) and, secondly, at the other of the longitudinal ends of the connector, the other central contact tip and the other outer contact radial end and, respectively, the signal line and the ground line of a second printed circuit board (PCB2) parallel to the first printed circuit board (PCB1) or a RF module or another printed circuit board (PCB3) perpendicular to the first printed circuit board (PCB1).

Preferably, the end of the two central contacts, each intended to be in contact with the PCB, is protruding relative to the corresponding end of the outer contact. This ensures permanent mechanical contact of the central contacts despite any potential radial misalignment or tilt angle.

The combination of radial outer contacts and tip central contacts allows the interfaces to remain centered in its docking position and to tolerate significant rotation, typically with a possible tilting angle > 10°, compared to a prior art interface with a pin-socket type centerline connection.

The mechanical and electrical reference plane is formed by the face of the printed circuit board in contact with one of the receptacle or ring.

According to an advantageous embodiment, the system includes four impedance coaxial lines with two end lines including solid insulators whereas the two central ones sliding into each other are insulated by air.

The characteristic impedance of each coaxial line and of the entire connection system remains at a stable value, typically 50 ohms, over the entire length of the connection system, regardless of the final distance between the PCBs to be connected by the system. It is also possible to obtain a stable impedance over the entire length of the connector at 75 ohms or any other value.

There is no impedance mismatch along the axis of the connection system in passing from one coaxial line to another: the presence of air predominantly in the coaxial lines avoids impedance variations between areas of solid insulation and air insulation that can be found in connectors according to the prior art.

The invention has many advantages over prior-art coaxial connection systems :

the possibility of getting significant axial misalignment and radial misalignment with exceptional RF performances at very high frequency, typically in the X band for low cost telecom products and Ka,V bands for products intended for electronically scanned antennas, while being very compact in the longitudinal axis;

the impedance of the coaxial lines forming the connection system according to the distance between PCBs, which remains stable, typically equal to 50 Ω.

keeping a simple structure, i.e. with a limited number of parts and a quick and simple assembly process.

Other advantages and features of the invention will become more clearly apparent upon reading the detailed description of exemplary implementations of the invention, given by way of non-limiting illustration with reference to the following figures.

### BRIEF DESCRIPTION OF THE DRAWINGS

FIG. 1 is a longitudinal section view of an example of a coaxial connection system according to a first embodiment of the invention, in a configuration connected between two parallel PCBs, without radial misalignment.

FIG. 2A is a side view of the connection system according to FIG. 1 in a configuration connected between two parallel PCBs, with radial misalignment.

FIG. 2B is a longitudinal cross sectional view of the connection system according to FIG. 1 in a configuration connected between two parallel PCBs, with radial misalignment.

FIG. 3 is a perspective view of the spring-loaded adapter of the system according to FIGS. 1 and 2A-B.

FIG. 4 is a perspective view of one of the receptacles of the system according to FIGS. 1 and 2A-B.

FIG. 5 is a perspective view of the other receptacle of the system according to FIGS. 1 and 2A-B.

FIG. 6 shows curves of simulation of reflection losses as a function of the frequency in various configurations of axial, radial and parallelism tolerances between two PCBs with a system according to the invention.

FIG. 7 is a variant of the receptacle including a cavity filter.

FIG. 8 is a perspective view showing the arrangement of the receptacle of the variant according to FIG. 6 into a PCB.

FIG. 9 is a perspective view of a variant of a receptacle with a terminal to allow a connection between a first PCB and another PCB arranged perpendicular to the first PCB.

FIG. 10 is a perspective view of the connection system with a receptacle according to the variant of FIG. 9 in a configuration connected between a first PCB and another PCB arranged perpendicular to the first PCB.

FIG. 11 shows in a perspective view a variant of a dual receptacle with a common terminal to allow a connection between a first PCB and another PCB arranged perpendicular to the first PCB.

FIG. 12 is a perspective view of two spring-loaded adapters with a dual receptacle according to the variant of FIG. 10.

FIG. 13 is a perspective view of an example of a coaxial connection system according to a second embodiment of the invention, in which the receptacles are replaced by annular rings mechanically retained by the adapter.

FIG. 14 is a longitudinal section and perspective view of an example of a coaxial connection system according to FIG. 13.

FIG. 15 is a perspective view of a multi-channel coaxial connection system comprising a plurality of coaxial spring loaded-adapters according to FIGS. 13 and 14 that are arranged in parallel with each other into an holder to connect two parallel PCBs.

### DETAILED DESCRIPTION

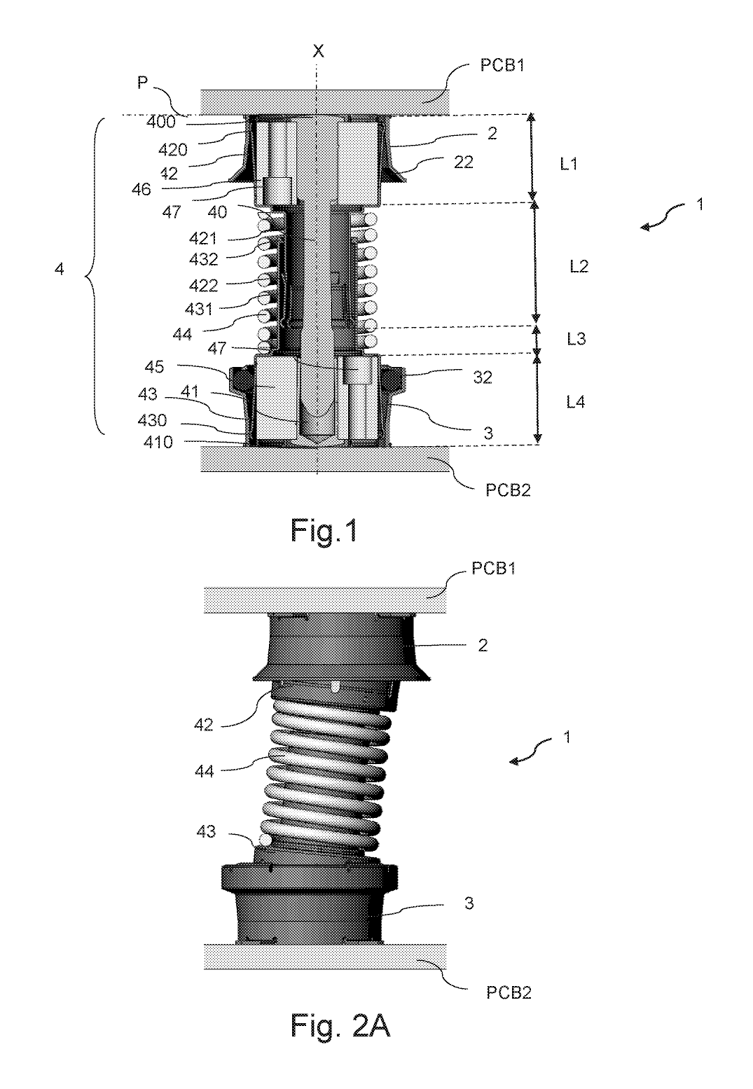

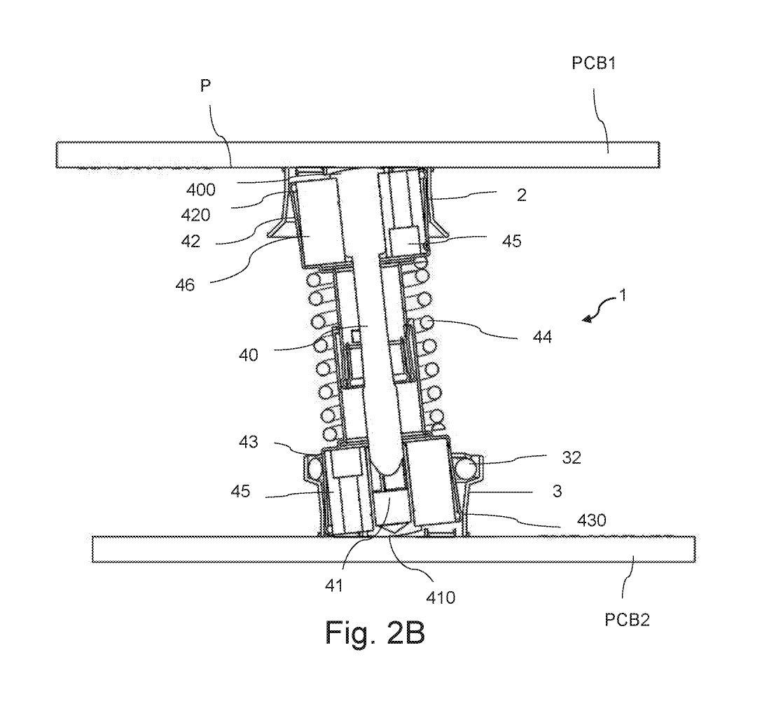

FIGS. 1 to 2B show a coaxial connection system 1 according to a first embodiment of the invention, in a configuration connected between two parallel PCB1, PCB2.

The connection system 1 extends along a longitudinal axis X and is intended to transmit radio frequency, RF signals. More particularly, it is intended to transmit signals either in the X band for the telecom applications, or in Ka and V bands, for products intended for electronic scanning antennas.

The system 1 comprises firstly two annular receptacles 2, 3, each intended to be in mechanical and electrical contact with one ground trace of the board PCB1 or PCB2.

In the shown embodiment, the receptacle 2 is a sliding type whereas the receptacle 3 is of the snap-on type.

A spring-loaded adapter 4 is arranged between the two receptacles 2, 3.

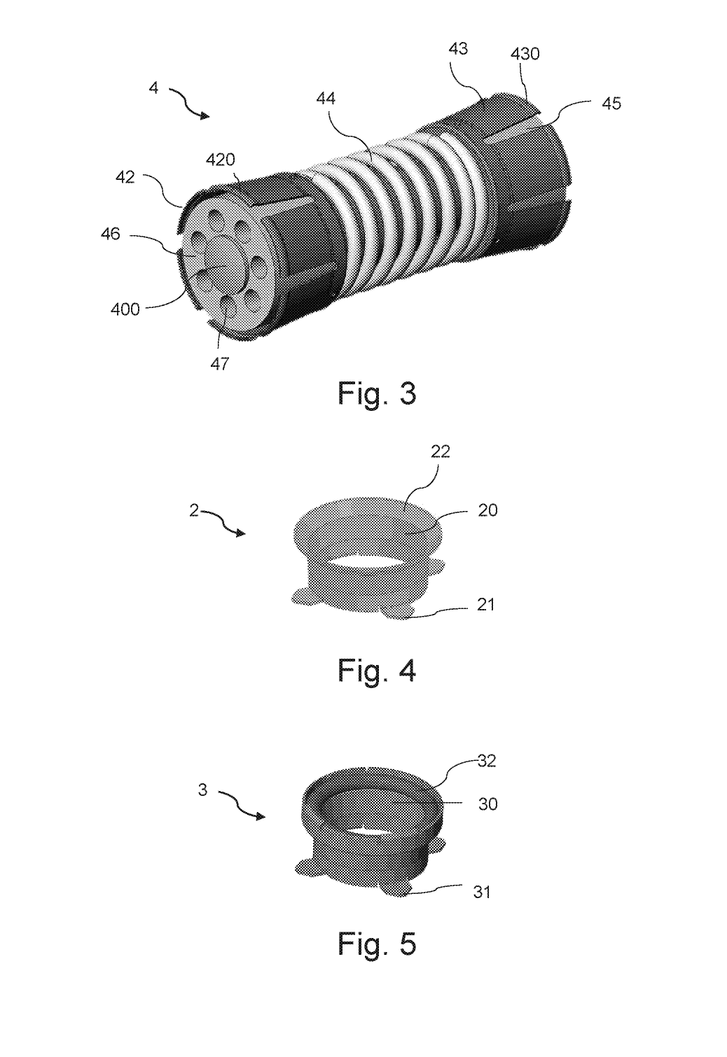

As shown in detail in FIGS. 1 and 3, the adapter 4 includes two central contacts 40, 41 sliding into each other. More precisely, the central contact 40 is of the male type which one end is sliding into the central contact 41 of the female type. Each of the central contacts 40, 41 has a free end which has a spherical portion shape 400, 410. This spherical portion 400, 410 allows an axial contact with the signal trace of each of the boards PCB1, PCB2.

Two outer contacts 42, 43 are sliding against each other. Each of the two outer contacts 42, 43 are mechanically guided by one of the two annular receptacles 2, 3 and are mechanically retained with and coaxially arranged around one of the two central contacts 40, 41.

The free end of each of the outer contact 42,43 is slotted defining contact petals each shaped at its front end with a bump 420, 430.

An helical spring 44 is arranged around the central portion of the two outer contacts 42, 43 and abuts the end portion of these latter. This spring 44 exerts a compression force to produce the electrical connection. In order to increase the compactness of the adapter, its external diameter is not larger than the maximum external diameter of the ground contacts.

The two receptacles 2, 3 serve to guide the spring-loaded adapter 44 and to ensure electrical contact between the printed circuit boards PCB1, PCB2 and the outer contacts 42, 43 of the adapter 4.

According to the invention, the two central contacts 40, 41 allows to ensure an electrical continuity by an axial mechanical pressure of its free end 400, 410 whereas each of the two outer contacts 42, 43 is configured to ensure an electrical continuity by a radial deformation of its free end 420, 430. This combination of the two distinctive types of electrical contact, i.e. axial by contact tips 400, 410 for the central contacts and radial by the bumps 420, 430 for the outer contacts, allows the interface of the system 1 to remain centered on its reception location and to be able to benefit from significant rotation, typically with a possible angle superior to 10°.

Preferably, the free end 400, 410 of each of the central contacts 40, 41 is protruding relative to the corresponding free end of the outer contact 42, 43. This ensures a permanent mechanical contact of the central contacts with the signal line of the boards PCB1, PCB2 despite any potential radial misalignment or any angle of inclination.

Preferably, the extremity 400, 410 of each of the central contacts 40, 41 is shaped as a spherical portion. This ensures a permanent and stable electrical contact of the central contacts with the signal line of the boards PCB1, PCB2 despite any potential radial misalignment or any tilt angle.

As shown on FIGS. 2A-B, in a maximum compression state with a consequent tilt angle, the radial electrical contact between the outer contacts 42, 43 of the adapter 4 and the receptacles 2, 3 stays very proximate to the surfaces of the PCB1, PCB2 boards which greatly limits the impedance mismatch zone and does not impact the signal integrity. This electrical active area only depends on the axial tolerance and on the maximum tilt angle accepted, i.e. this area is thin.

The height of the receptacles 2, 3 only allows to limit the angular variation and to guide the adapter 4 during the mating.

FIG. 4 shows the electrically conductive body 20 which forms the sliding receptacle 2. The base of the body 20 advantageously has lugs 21 orthogonal to the axis X which are intended to be used for permanent electrical and mechanical connection to the printed circuit board (PCB1), in particular by welding, allowing surface mounting in accordance with SMT technology. These lugs 21 could also be arranged parallel to the axis X for through-welding to the PCB, or press-fit mounting inside a hole in the PCB. The large top flaring 22 of the body 20 mechanically guides the adapter 4 during blind mating.

FIG. 5 shows the electrically conductive body 30 which forms the snap-on receptacle 3. The base of the body 30 advantageously has lugs 31 orthogonal to the axis X which are intended to be used for permanent electrical and mechanical connection to the printed circuit board (PCB2), in particular by welding, allowing surface mounting in accordance with SMT technology. These lugs 31 could also be arranged parallel to the axis X for through-welding to the PCB, or press-fit mounting inside a hole in the PCB. The body 30 accommodates an O-ring 32 which allows the inclined adapter 4 to be straightened in the event of the receptacle 3 becoming disconnected from the printed circuit board PCB2.

The receptacles 2, 3 are made of a conductive material such as brass. In a variant, the receptacles are made of polymer material such as liquid crystal polymers (LCP). Only the zone of electrical contact with the outer contact of the adapter, i.e. the internal proximate end to the PCB, is metalized to insure the electrical contact.

Thanks to its structure, the adapter 4 always remains in contact with the mechanical and electrical reference plane P defined by the PCB1, PCB2.

In the shown embodiment, the connection system 1 comprises four coaxial impedance lines L1 to L4. The characteristic impedance of each coaxial line L1 to L4 and of the entire connection system remains at a stable value of 50 ohms, over the entire length of the connection system.

Each of the two end lines L1 and L4 includes an electrical insulating body 45, 46 interposed and mechanically retained between one of the two central contacts 40, 41 and the two outer contacts 42, 43.

This insulating body 45, 46 is a low dielectric loss insulator that allows the central male contact 40 and the central female contact 41 to be maintained. This insulator can be made of PTFE for example. As shown, this body 45, 46 includes preferably through holes 47 which allow to precisely adapt the line impedance.

The external diameter of the central contact 40 in the coaxial line L1 is larger than the diameters in lines L2 or L3. This facilitates the insertion of the contacts in the bodies during the assembling phase.

Lines L1 and L4 are preferably of identical dimensions and give symmetry to the adapter 4. It also limits the number of distinct parts included in the system and simplifies its structure.

Each of the two inside lines L2 and L3 is devoid of a solid electrical insulator, i.e. air is the insulator in these lines.

Lines L2 and L3 slide inside each other, with line L2 being of fixed length and line L3 of variable length. The stroke of line L3 defines the maximum permissible axial misalignment. Whatever the length of line L3 is, its characteristic impedance remains identical.

In these inside coaxial lines L2, L3, the outer contact 42 has a central portion of male type 421 fitted into a central portion of female type 431 of the outer contact 43. The outer male contact 42 comprises a claw 422 which extends outwards and which cooperates with an internal shoulder 432 of the outer female contact 43 so as to keep the two central portions 421, 422 fitted into one another regardless of the separation force exerted by the compression spring 44.

To achieve the constant impedance at 50 Ohm, the relative dielectric constant of the insulator 42, 43 of lines L1 and L4 is defined so that:

the diameters of lines L2 and L3 are significantly smaller than the diameters of lines L1 and L4 and allow for the insertion of the helical spring 44 to generate compression greater than the insertion forces of the petals defining the bumps 420, 430 of the bodies 42, 43 and greater than the sliding forces of inside portions 421, 431 of the outer contacts 42, 43 and of the central contacts 40, 41;

the diameter of the male central contact 40 in line L1 is the largest diameter and allows for easy insertion from the outside in;

the diameters of the male central contact 40 are large enough to serve as a framework for the entire system.

More particularly, the male central contact 40 has at least three distinct diameters, which allows for maintaining an impedance of 50 ohms on lines L1, L2 and L3 regardless of the compression state of the variable line L3.

As already mentioned, the structure with the two sliding lines L2, L3 insulated by air allows a constant impedance to be maintained regardless of the relative positioning of the boards PCB1, PCB2.

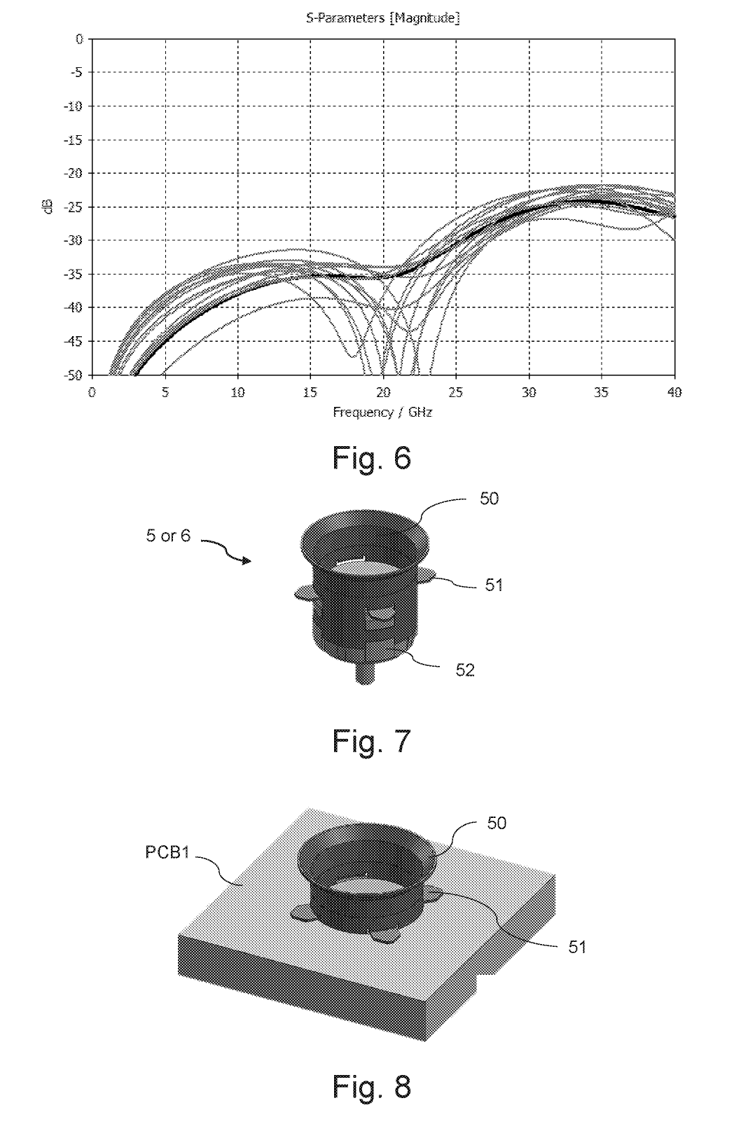

The inventors have confirmed with success the constant impedance of such a system 1 by simulating reflection losses as a function of axial, radial and parallelism tolerances between two PCBs, with a model optimized for signals in the Ka band, as shown on FIG. 6. On this FIG. 6, the black nominal curve is simulated with no tilt angle and nominal compression. The grey curves relate to configurations with tilt angles and/or additional compression. Compared to the black nominal curve, the global increase of losses of the grey curves stays low, and the maximum losses stay below -20 dB (decibel), especially at very high frequencies, even with configurations with maximum tilt angle and/or maximum compression.

In advantageous variants, the guide and electrical continuity receptacles can be adapted to accommodate cavity filters.

FIG. 7 thus shows the electrically conductive body 50 which forms the sliding receptacle 5 including a cavity filter 52. The base of the body 50 advantageously has lugs 51 orthogonal to the axis X which are intended to be used for permanent electrical and mechanical connection to the printed circuit board (PCB1), in particular by welding, allowing surface mounting in accordance with SMT technology. These lugs 51 could also be arranged parallel to the axis X for through-welding to the PCB, or press-fit mounting inside a hole in the PCB as shown on FIG. 8.

The other receptacle 6 can be made as the sliding receptacle 5.

As shown on FIG. 8, the electrical continuity function of the receptacles 5, 6 is achieved only over a very low height of the receptacle, typically less than 1 mm. The remaining height serves, on the one hand, to limit the permitted angular variation and facilitate easy docking during blind mating of the adapter 4. The mismatch zone on the PCB surface is thus reduced to a minimum to avoid disrupting the transmission of high-frequency signals: this zone only allows for radial misalignment. This decoupling of the electrical function from the mechanical part allows the electrical function to be implemented directly in the filter or RF module panel, resulting in a significant reduction in interconnection costs.

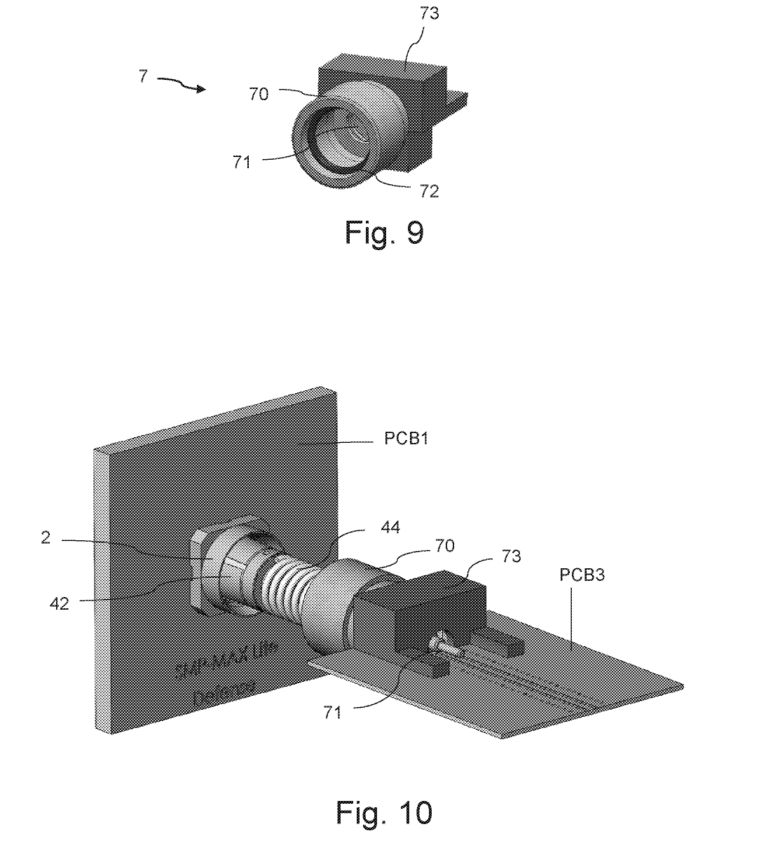

FIG. 9 shows another variant of the snap-on receptacle 7. The electrically conductive body 70 includes and is electrically connected to terminal 71 supported by a block 73 to allow the system 1 to connect a board PCB1 to another board PCB3, usually called “edge card” which is arranged perpendicular to PCB1, such as shown on FIG. 10. As in the previous embodiment, the body 70 can also accommodate an O-ring 72.

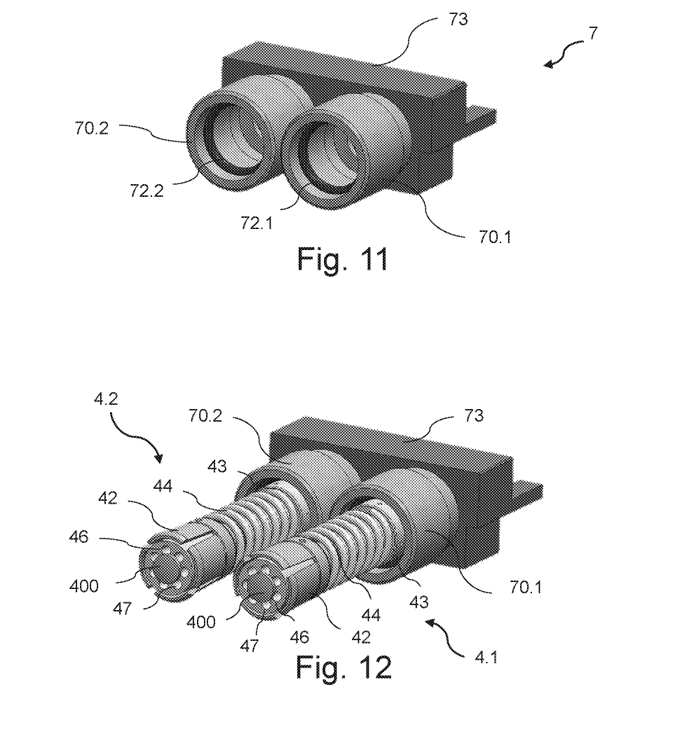

FIG. 11 shows the variant with a twin snap-on receptacle 7.1, 7.2, preferably identical, supported by a common block 73 which allows system 1 to achieve a connection with an edge card.

FIG. 12 shows the mounting of each of two adapters 4.1, 4.2, preferably identical, in each of the twin snap-on receptacles 7.1, 7.2.

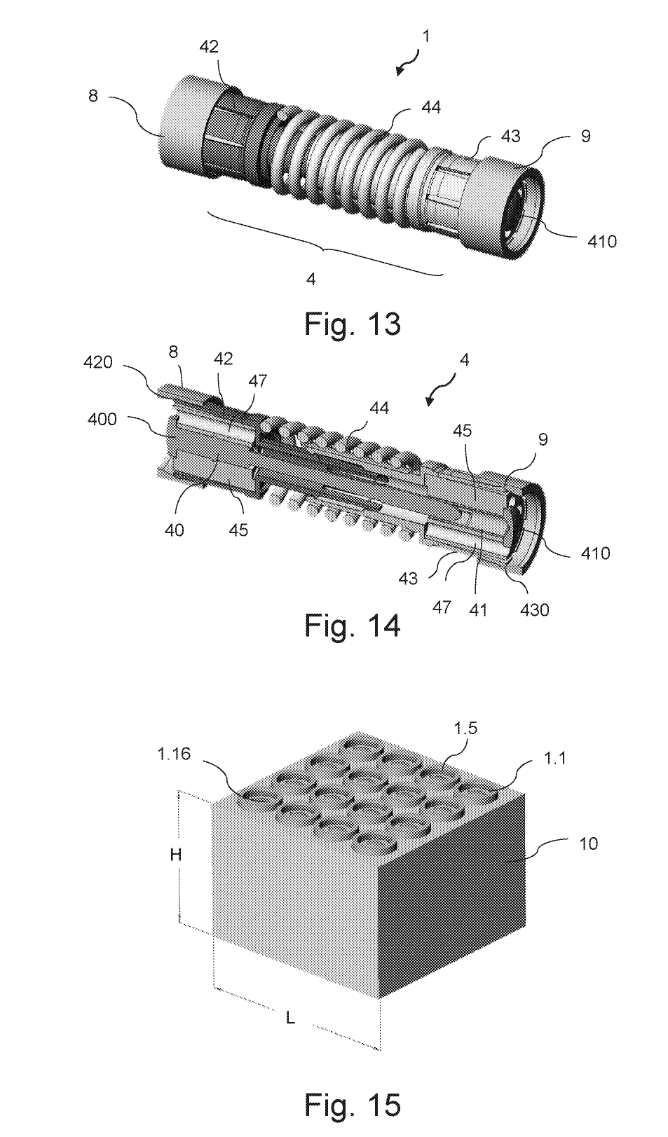

FIGS. 13 and 14 show another embodiment of the invention according to which receptacles 2, 3 or 5, 6 are replaced by annular rings 8, 9 directly secured to the adapter 4 by the petals of the outer contacts 40, 41.

In other words, in this other embodiment, the adapter 4 constitutes by itself the whole interconnection system 1.

In this another embodiment, the central electrical continuity is always ensured by the free end 400, 410 shaped with a spherical portion of the central contacts 40, 41 whereas the outer electrical continuity is ensured by the radial deformation of the bumps 420, 430 of the outer contacts 42, 43 each directly in contact with annular rings 8, 9.

The annular rings 8, 9 are intended to be directly in contact with the ground lines of the boards PCB1, PCB2 to be connected together.

With a plurality of adapters 4 securing the annular rings 8, 9 it is possible to achieve a connection module, intended to be used to link two printed circuit boards PCB1, PCB2. comprising:

Thus, as shown in FIG. 15, an holder comprising a frame 10 with a plurality of openings arranged parallel to each other and in each of which one of the adapters forming a whole system 1.1 to 1.16 is accommodated according to a floating mounting. This holder can be very compact. For example, the dimensions L x H of such holder 10 may be equal to 9 x 6.35 mm for a number of 16 adapters.

Other variants and improvements may be provided without thereby departing from the scope of the invention.

1. A coaxial connection system, suitable to connect two printed circuits boards or one board to a filter or one board to a module, for transmitting radio frequency, RF signals, said system having a longitudinal axis X and comprising:
two annular receptacles or rings, each intended to be in mechanical and electrical contact with one ground trace of the board or the filter or the module;
a spring-loaded adapter including:
two central contacts sliding into each other,
two outer contacts sliding each other, each of the two outer contacts being mechanically guided by one of the two annular receptacles or rings and mechanically retained with and coaxially arranged around one of the two central contacts, and
an helical spring arranged around the two outer contacts,
wherein each of the two central contacts is configured to ensure an electrical continuity by an axial mechanical pressure of its free end whereas each of the two outer contacts is configured to ensure an electrical continuity by a radial deformation of its free end.

2. A coaxial connection system according to claim 1, wherein the outer contacts are configured to not be in mechanical contact with two printed circuits boards or the board and the filter or the board and the module.

3. A coaxial connection system according to claim 1, wherein the central contacts are configured to be in direct mechanical and electrical contact by their free end with two printed circuits boards (PCB1, PCB2) or the board and the filter or the board and the module.

4. A coaxial connection system according to claim 3, wherein the free end are shaped as a spherical portion.

5. A coaxial connection system according to claim 1, wherein the free end of each of the outer contact is slotted defining contact petals each shaped at its front end with a bump.

6. A coaxial connection system according to claim 1, comprising four impedance lines, each of the two end lines including an electrical insulating body interposed and retained between one of the two central contacts and the two outer contacts, each of the two inside lines being devoid of a solid electrical insulator.

7. A coaxial connection system according to claim 6, wherein the diameter of one of the central contact decreases from the free end at least one of the end lines to the intermediate lines.

8. A coaxial connection system according to claim 6, wherein the external diameter of the outer contacts in end lines is larger than in intermediate lines.

9. A coaxial connection system according to claim 1, wherein one of the two receptacles is of a sliding type whereas the other receptacle being of the snap-on type.

10. A coaxial connection system according to claim 1, wherein at least one receptacle accommodating an O-ring or a toroidal spring retains one of the two outer contacts.

11. A coaxial connection system according to claim 10, wherein each of the receptacles accommodates a cavity filter.

12. A coaxial connection system according to claim 8, wherein one of the two receptacles is assembled with a terminal to make a perpendicular board-to-board , called an edge card, connection.

13. A coaxial connection system according to claim 1, wherein the annular rings are mechanically retained by the outer contacts and thus assembled with the adapter.

14. A connection module, intended to be used to link two printed circuit boards comprising:
at least one coaxial connection system constituted by the adapter according to claim 13;
a holder comprising a frame with at least one opening in which the adapter is accommodated according to a floating mounting.

15. The connection module according to claim 14, wherein the frame comprises a plurality of openings arranged parallel to each other, in each of which one of the adapters is accommodated according to a floating mounting.
